(19) United States
(12) Patent Application Publication
(10) Pub. No.: US 2026/0299692 A1
(43) Pub. Date: Oct. 1, 2026

(54) COMPUTING DEVICE WITH HAPTIC VIBRATION TUNING

(71) Applicant: Microsoft Technology Licensing, LLC, Redmond, WA (US)

(72) Inventor: Amnon Dan FREIDLIN, Brooklyn, NY (US)

(73) Assignee: Microsoft Technology Licensing, LLC, Redmond, WA (US)

(21) Appl. No.: 19/096,028

(22) Filed: Mar. 31, 2025

(51) Int. Cl. G06F 3/01; G06F 3/04847

(52) U.S. Cl. CPC G06F 3/016; G06F 3/04847

(57) ABSTRACT

A computing device with haptic tuning includes a haptic motor configured to emit a haptic vibration, memory storing instructions, and a processor configured to execute the instructions to perform various functions. The computing device executes a haptics engine configured to control the haptic motor and adjust the haptic vibration to be emitted, receives haptic parameters including at least a pitch of a sound of the haptic vibration to be emitted, converts the pitch to a vibration frequency value, and controls the haptic motor to emit the haptic vibration at the vibration frequency value such that the sound of the haptic vibration is tuned to match the pitch.

### BACKGROUND

Many computing devices, particularly wearable or handheld devices such as smartphones, include a haptic unit that causes emissions of haptic vibrations. The vibrations can be used to provide notifications, feedback, or an immersive experience when using the computing device. The haptic unit can be programmed to change the haptic output to be appropriate for different situations and enable the user to differentiate the intended notification by feel. For example, a short, soft burst may notify the user of a non-urgent message, while a sustained, harsh vibration may notify the user of an incoming call. In addition to duration and intensity, various patterns may be produced.

Another parameter used to describe haptic vibrations is the frequency at which the haptic unit and connected components vibrate, sometimes simplified as “sharpness,” which can correlate to the perceived rigidity or hardness of the impulse, where 0 is a low sharpness value and 1 is a high sharpness value. Different sharpness values or vibration frequencies can convey different messages, tones, or feelings to the user. However, these different vibration frequencies produce discernibly different audible buzzing sounds. Such sounds may be discordant or incongruous with audio cues played by the computing device even if the sharpness is set to the desired value. Furthermore, the buzzing may represent an extra noise in an already busy and chaotic environment of the user, and the user may not be receptive to the message being conveyed.

### SUMMARY

To address the issues discussed herein, a computing device with haptic tuning is provided. The computing device may include a haptic motor configured to emit a haptic vibration, and memory storing instructions. The computing device may include a processor configured to execute the instructions to execute a haptics engine configured to control the haptic motor and adjust the haptic vibration to be emitted. The processor may be configured to execute the instructions to receive haptic parameters including at least a pitch of a sound of the haptic vibration to be emitted, convert the pitch to a vibration frequency value, and control the haptic motor to emit the haptic vibration at the vibration frequency value such that the sound of the haptic vibration is tuned to match the pitch.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system including a computing device with haptic tuning according to one implementation of the present disclosure.

FIG. 2 shows an exemplary conversion table usable by the computing device of FIG. 1.

FIG. 3 shows an exemplary melody playable by the computing device of FIG. 1.

FIG. 4 shows an exemplary graphical user interface (GUI) of the computing device of FIG. 1.

FIG. 5 shows a flowchart of an example method for haptic tuning in the computing device of FIG. 1.

FIG. 6 shows a schematic view of an example computing environment in which the computing system of FIG. 1 may be enacted.

### DETAILED DESCRIPTION

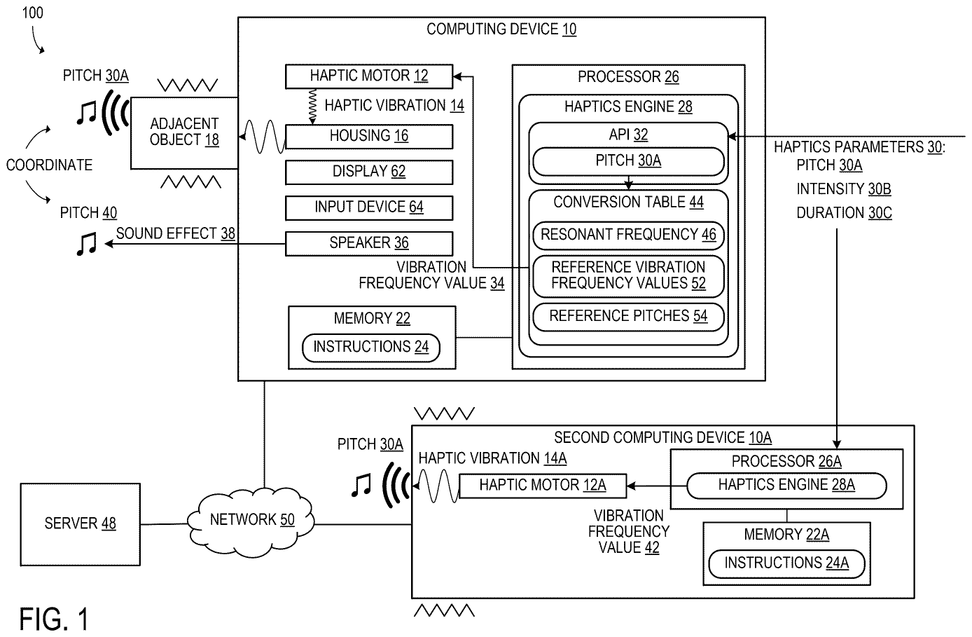

As illustrated in FIG. 1, to address the above identified issues, a computing system 100 is provided. The computing system 100 includes a computing device 10 with haptic tuning. The computing device 10 may be, for example, a mobile device such as a tablet computing device, wearable computing device, or smartphone, or a gaming device such as a gaming console with associated controller. Such devices often utilize haptic feedback for communication with a user and therefore may be improved by the haptic tuning techniques disclosed herein. Regardless of the type of device, the computing device 10 may include a haptic motor 12 configured to emit a haptic vibration 14. The haptic motor 12 may be an eccentric rotation mass motor, linear resonant actuator, or linear magnetic ram motor, for example. The computing device 10 may include a housing 16, and the haptic motor 12 may be directly or indirectly coupled to the housing 10. In some instances, the haptic motor 12 may be positioned inside the housing 16. By closely coupling the haptic motor 12 to the housing, the haptic vibration 14 emitted by the haptic motor 12 may cause the housing 16 itself to vibrate, and may further cause conduction of the haptic vibration 14 to an adjacent object 18 such as a table or countertop upon which the computing device 10 is placed. Vibrating the adjacent object 18 may result in amplification of a sound of the haptic vibration 14, increasing a user's audible perception of the haptic vibration 14.

The computing device 10 may include memory 22 storing instructions 24 and a processor 26 configured to execute the instructions 24 to exhibit various features described herein. For example, the processor 26 may be configured to execute the instructions 24 to execute a haptics engine 28 configured to control the haptic motor 12 and adjust the haptic vibration 14 to be emitted. The haptics engine 28 may thus be usable to adjust the performance of the haptic motor 12 to produce different haptic vibrations 14. The processor 26 may be configured to execute the instructions 24 to receive haptic parameters 30 including at least a pitch 30A of the sound of the haptic vibration 14 to be emitted. Thus, a user (an end user or a programmer, for example) may be able to customize the sound of the haptic vibration 14 by controlling the haptic motor 12 to produce the specified pitch 30A. The haptics engine 28 may include an application programming interface (API) 32 configured to receive the haptic parameters 30 from a user. The haptic parameters 30 may further include additional parameters such as an intensity 30B and a duration 30C, and therefore the haptics engine 28 may be configured to control the haptic motor 12 to emit the haptic vibration 14 at the intensity 30B and for the duration 30C of the haptic parameters 30, giving the user or programmer increased control over the haptic vibration 14 and widening the potential uses thereof.

As mentioned above, sharpness represents the perceived rigidity or hardness of a haptic impulse. The haptic motor 12 may not be configured to directly respond to the pitch 30A itself, and instead, the processor 26 may be configured to execute the instructions 24 to convert the pitch 30A to a vibration frequency value 34 to which the haptic motor 12 is programmed to respond. It will be appreciated that the vibration frequency value 34 may be a direct frequency value (e.g., in Hertz) or may be a stand-in value representing frequency such as sharpness. Generally, the vibration frequency can be adjusted by adjusting a frequency of a control signal from the processor 26 to the haptic motor 12, whereas the intensity can be adjusted by adjusting an amplitude of the control signal. Then, the processor 26 may be configured to execute the instructions 24 to control the haptic motor 12 to emit the haptic vibration 14 at the vibration frequency value 34 such that the sound of the haptic vibration is tuned to match the pitch 30A set in the haptic parameters 30. In this manner, the computing device 10 may be programmed to adjust the perceived sound of the haptic vibration 14 to have a higher or lower pitch, thereby tuning the haptic vibration 14 to a specific note. As such, the use of haptic feedback in the computing device 10 can be expanded beyond intensity, duration, and sharpness, creating opportunities for a more complex and varied user experience.

One example of how haptic tuning can be utilized is exhibited when the computing device 10 further comprises a speaker 36 configured to emit a sound effect 38. As illustrated in FIG. 1, the computing device 10 may coordinate the pitch 30A of the haptic vibration with a pitch 40 of the sound effect 38. In one implementation, the processor 26 may be configured to harmonize the pitch 30A of the haptic vibration 14 with the pitch 40 of the sound effect 38. Harmonizing the two pitches 30A, 40 may provide a delightful, complex cue for the user. In another implementation, the processor 26 may be configured to control the pitch 30A of the haptic vibration 14 to minimize dissonance with the sound effect 38. In this manner, the cacophony of noises to which the user is subjected to in daily life may be reduced so as to not contribute to overstimulation of the user. The processor 26 may even be configured to control the pitch 30A of the haptic vibration 14 to match the pitch 40 of the sound effect 38.

The computing device 10 may be considered a first computing device, and the computing system 100 may further include a second computing device 10A with haptic tuning. Like the computing device 10, the second computing device 10A may include a respective haptic motor 12A configured to emit a haptic vibration 14A, memory 22A storing instructions 24A, processor 26A configured to execute the instructions 24A to exhibit various features described herein. For example, the processor 26A may be configured to execute the instructions 24A to execute a haptics engine 28A configured to control the haptic motor 12A and adjust the haptic vibration 14A to be emitted, receive the haptic parameters 30 including at least the pitch 30A of a sound of the haptic vibration 14A to be emitted, convert the pitch 30A to a vibration frequency value 42, and control the haptic motor 12A to emit the haptic vibration 14A at the vibration frequency value 42 such that the sound of the haptic vibration 14A is tuned to match the pitch 30A. Here, the same haptic parameters 30 received by the computing device 10 are also received by the second computing device 10A.

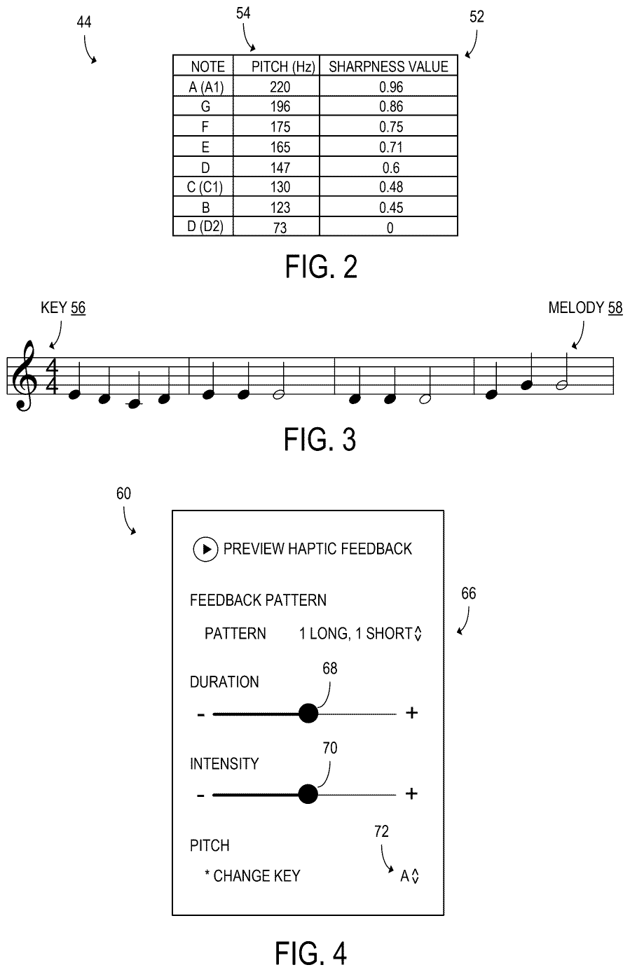

Interestingly, the pitch 30A of the haptic vibration 14 is substantially the same pitch as the pitch 30A of the haptic vibration 14A emitted by the second computing device 10A executing the respective haptics engine 28A, even when the first computing device 10 and the second computing device 10A are different models, form factors, or brands of devices (i.e., are produced and/or sold by different manufacturers). The computing system 100 is able to maintain consistency across disparate devices like this by adjusting the conversion between pitch and sharpness to account for differences between the devices. Thus, the vibration frequency value 42 may be different than the vibration frequency value 34. For example, the conversion table 44 shown in FIG. 2 may be utilized. The conversion table 44 may be stored in the memory 22 and list different notes playable by the haptic motor 12 and their corresponding pitches. The number of entries in the conversion table 44 is not particularly limited and may commonly range from 10-300 Hz for pitch in typical hardware, although more specialized hardware may be utilized to produce pitches outside of this range.

The processor 26 may be further configured to determine a resonant frequency 46 (see FIG. 1) of the computing device 10. The resonant frequency 46 may be determined by retrieval from a server 48 via a network 50, receiving an input value, or performing sound testing via a microphone, etc. The processor 26 may be configured to modify the conversion table of reference vibration frequency values 52 (for example, reference sharpness values indicative of frequency) and reference pitches 54 by the resonant frequency 46, and convert the pitch 30A to the vibration frequency value 34 based on the conversion table 44. That is, the conversion table 44 of the computing device 10 may look as illustrated, but the conversion table for another device such as the second computing device 10A would have the same notes and corresponding reference pitches 54, but adjusted vibration frequency values that would result in the same reference pitches 54. The processor 26 may be configured to make this modification by, for example, utilizing a known resonant frequency 46 for the specific computing device 10 or haptic motor 12 being analyzed with a table generating algorithm. The known resonant frequency 46 may be stored in the memory 22 with other resonant frequencies or retrieved from the Internet. In another example, the processor 26 may be configured to test various vibration frequencies in a device-specific way, by conducting empirical tests on different computing devices 10 to determine how various vibration frequencies affect the perceived pitch (audio frequency), and populate the conversion table 44 with actual output frequencies and corresponding pitches as the reference pitches 54 and the reference vibration frequency values 52 for each computing device 10. Then, for any other computing device 10A having a different resonant frequency 46 affecting the perceived pitch 30A being emitted, empirical tests may be conducted and the conversion table 44 modified to contain updated reference values as a result of the tests.

As shown in both FIGS. 2 and 3, the haptics engine 28 may be configured to control the haptic motor 12 to emit a plurality of haptic vibrations 14 having respective pitches 30A selected from a predetermined musical key 56. By way of illustration, the key 56 shown in FIG. 3 is C major. By sticking to the key 56, the API 32 can provide a set of notes from which the user may select when programming cues, patterns, etc. from the haptic vibrations 14, and even without substantial musical knowledge, the user can more easily avoid discordant noises. FIG. 3 shows an exemplary melody playable by the computing device of FIG. 1. In this more specific implementation, the haptics engine 28 may be configured to control the haptic motor 12 to emit a series of haptic vibrations 14 tuned to a melody 58 of corresponding pitches 30A. Here, the haptics engine 28 may be configured to play the melody 58 “Mary Had a Little Lamb” in the key 56 of C major by controlling the vibration frequency value 34 and the duration 30C of the emitted haptic vibrations 14. In this manner, the haptic motor 12 may be tuned to play recognizable songs, jingles, “buzz tones,” etc. where previously only monotonous single notes or limited and out-of-key pitches clashing with one another were possible.

FIG. 4 shows an exemplary graphical user interface (GUI) 60 of the API 32, displayable on a display 62 of the computing device 10 of FIG. 1. The GUI 60 provides a way for the user to input the haptic parameters 30 to the API 32 via an input device 64 of the computing device 10 of FIG. 1. In the illustrated example, the GUI 60 includes a pattern selector 66 for optionally selecting a pattern of multiple haptic vibrations 14 from a saved list of patterns, a duration selector 68 for controlling the duration of the haptic vibrations 14, an intensity selector 70 for controlling the intensity of the haptic vibrations 14, and a pitch selector 72 for controlling the pitch of the haptic vibrations 14. It will be appreciated that the GUI 60 is merely an example and many different formats or options may be utilized. Furthermore, the customization options may be presented independently for each haptic vibration 14 within a larger patterns to create even greater variation.

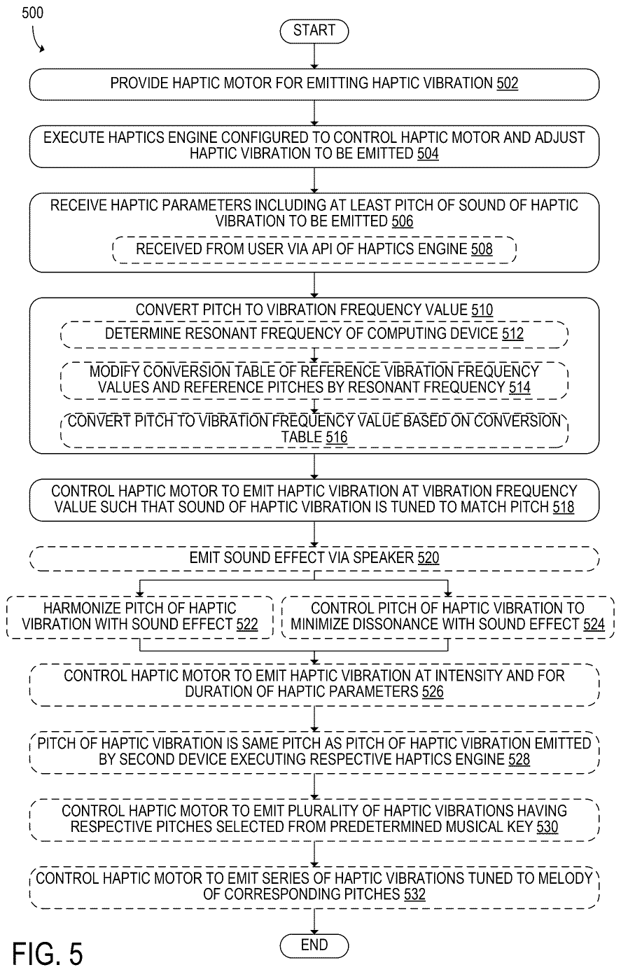

FIG. 5 shows a flowchart of an example method 500 for haptic tuning. The method 500 may be implemented by the computing device 10 illustrated in FIG. 1, or any other suitable system.

At 502, the method 500 may include providing a haptic motor for emitting a haptic vibration. At 504, the method 500 may include executing a haptics engine configured to control the haptic motor and adjust the haptic vibration to be emitted. At 506, the method 500 may include receiving haptic parameters including at least a pitch of a sound of the haptic vibration to be emitted. Optionally, at 508, the haptic parameters may be received from a user via an application programming interface (API) of the haptics engine. Allowing for this kind of user input gives the user greater control over the haptic output of the computing device in a simple manner.

At 510, the method 500 may include converting the pitch to a vibration frequency value. More specifically, optionally, at 512, the method 500 may include determining a resonant frequency of the computing device. At 514, the method 500 may include modifying a conversion table of reference vibration frequency values and reference pitches by the resonant frequency, and at 516, the method 500 may include converting the pitch to the vibration frequency value based on the conversion table. In this manner, the pitch which is more familiar to users can be easily and automatically be converted to sharpness, which is a parameter by which the haptic motor is capable of being controlled.

Finally, at 518, the method 500 may include controlling the haptic motor to emit the haptic vibration at the vibration frequency value such that the sound of the haptic vibration is tuned to match the pitch. In this manner, the pitch can be used by users with less expertise in haptics to easily form complex and interesting haptic feedback cues. Optionally, at 520, the method 500 may include emitting a sound effect via a speaker. In this case, at 522, the method 500 may include harmonizing the pitch of the haptic vibration with the sound effect, or at 524, the method 500 may include controlling the pitch of the haptic vibration to minimize dissonance with the sound effect. With either option, the computing device is able to coordinate the tuned haptic vibration with the sound effect in a way that is agreeable to the end user. In any of the provided implementations, the computing device may be a mobile device, tablet computing device, wearable computing device, or gaming device, for example. Such devices often make use of haptics and therefore would be particularly improved by the haptic tuning techniques described herein.

Optionally, the haptic parameters may further include an intensity and a duration, and at 526, the method 500 may include controlling the haptic motor to emit the haptic vibration at the intensity and for the duration of the haptic parameters. Thus, the user may be provided with even more options for further customization of the haptic vibration. When the computing device is a first computing device, at 528, the pitch of the haptic vibration may be substantially the same pitch as a pitch of a haptic vibration emitted by a second device executing a respective haptics engine, even when the first computing device and the second computing device are different models, form factors, or brands of devices. In this manner, uniformity of pitch across different devices may be enforced.

Optionally, at 530, the method 500 may include controlling the haptic motor to emit a plurality of haptic vibrations having respective pitches selected from a predetermined musical key. Additionally or alternatively, at 532, the method 500 may include controlling the haptic motor to emit a series of haptic vibrations tuned to a melody of corresponding pitches. In this manner, the user can easily compose a variety of haptic patterns and avoid discordant or out of tune pitches.

In some embodiments, the methods and processes described herein may be tied to a computing system of one or more computing devices. In particular, such methods and processes may be implemented as a computer-application program or service, an application-programming interface (API), a library, and/or other computer-program product.

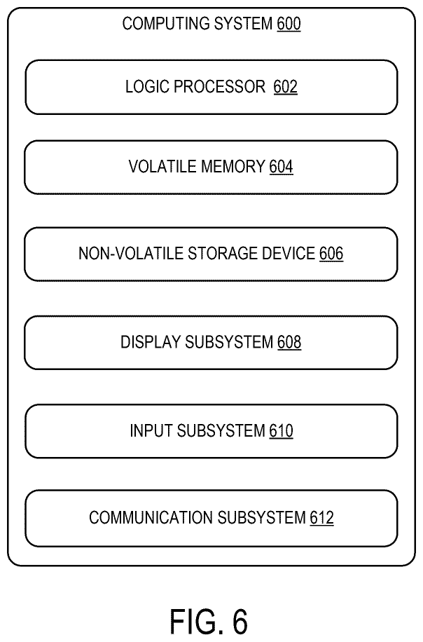

FIG. 6 schematically shows a non-limiting embodiment of a computing system 600 that can enact one or more of the methods and processes described above. Computing system 600 is shown in simplified form. Computing system 600 may embody the computing system 1 described above and illustrated in FIG. 1. Components of computing system 600 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 6.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs provide additional support for the claims of the subject application. One aspect provides a computing device with haptic tuning. The computing device comprises a haptic motor configured to emit a haptic vibration, memory storing instructions, and a processor. The processor is configured to execute the instructions to execute a haptics engine configured to control the haptic motor and adjust the haptic vibration to be emitted, receive haptic parameters including at least a pitch of a sound of the haptic vibration to be emitted, convert the pitch to a vibration frequency value, and control the haptic motor to emit the haptic vibration at the vibration frequency value such that the sound of the haptic vibration is tuned to match the pitch. In this aspect, additionally or alternatively, the computing system may further comprise a speaker configured to emit a sound effect, and the processor may be further configured to harmonize the pitch of the haptic vibration with the sound effect. In this aspect, additionally or alternatively, the computing system may further comprise a speaker configured to emit a sound effect, and the processor may be further configured to control the pitch of the haptic vibration to minimize dissonance with the sound effect. In this aspect, additionally or alternatively, the computing device may be a mobile device, tablet computing device, wearable computing device, or gaming device. In this aspect, additionally or alternatively, the haptics engine may include an application programming interface (API) configured to receive the haptic parameters from a user, the haptic parameters may further include an intensity and a duration, and the haptics engine may be configured to control the haptic motor to emit the haptic vibration at the intensity and for the duration of the haptic parameters. In this aspect, additionally or alternatively, the computing device may be a first computing device, the pitch of the haptic vibration may be substantially the same pitch as a pitch of a haptic vibration emitted by a second device executing a respective haptics engine, and the first computing device and the second computing device may be different models, form factors, or brands of devices. In this aspect, additionally or alternatively, the processor may be further configured to determine a resonant frequency of the computing device, modify a conversion table of reference vibration frequency values and reference pitches by the resonant frequency, and convert the pitch to the vibration frequency value based on the conversion table. In this aspect, additionally or alternatively, the haptics engine may be configured to control the haptic motor to emit a plurality of haptic vibrations having respective pitches selected from a predetermined musical key. In this aspect, additionally or alternatively, the haptics engine may be configured to control the haptic motor to emit a series of haptic vibrations tuned to a melody of corresponding pitches.

Another aspect provides a method for haptic tuning in a computing device. The method comprises providing a haptic motor for emitting a haptic vibration, executing a haptics engine configured to control the haptic motor and adjust the haptic vibration to be emitted, receiving haptic parameters including at least a pitch of a sound of the haptic vibration to be emitted, converting the pitch to a vibration frequency value, and controlling the haptic motor to emit the haptic vibration at the vibration frequency value such that the sound of the haptic vibration is tuned to match the pitch. In this aspect, additionally or alternatively, the method may further include emitting a sound effect via a speaker, and harmonizing the pitch of the haptic vibration with the sound effect. In this aspect, additionally or alternatively, the method may further include emitting a sound effect via a speaker, and controlling the pitch of the haptic vibration to minimize dissonance with the sound effect. In this aspect, additionally or alternatively, the computing device may be a mobile device, tablet computing device, wearable computing device, or gaming device. In this aspect, additionally or alternatively, the haptic parameters may be received from a user via an application programming interface (API) of the haptics engine, the haptic parameters may further include an intensity and a duration, and the method may further include controlling the haptic motor to emit the haptic vibration at the intensity and for the duration of the haptic parameters. In this aspect, additionally or alternatively, the computing device may be a first computing device, the pitch of the haptic vibration may be substantially the same pitch as a pitch of a haptic vibration emitted by a second device executing a respective haptics engine, and the first computing device and the second computing device may be different models, form factors, or brands of devices. In this aspect, additionally or alternatively, the method may further include determining a resonant frequency of the computing device, modifying a conversion table of reference vibration frequency values and reference pitches by the resonant frequency, and converting the pitch to the vibration frequency value based on the conversion table. In this aspect, additionally or alternatively, the method may further include controlling the haptic motor to emit a plurality of haptic vibrations having respective pitches selected from a predetermined musical key. In this aspect, additionally or alternatively, the method may further include controlling the haptic motor to emit a series of haptic vibrations tuned to a melody of corresponding pitches.

Another aspect provides a computing system. The computing system comprises a first computing device with haptic tuning, and a second device with haptic tuning, each device respectively comprising a haptic motor configured to emit a haptic vibration, memory storing instructions, and a processor configured to execute the instructions to execute a haptics engine configured to control the haptic motor and adjust the haptic vibration to be emitted, receive haptic parameters including at least a pitch of a sound of the haptic vibration to be emitted, convert the pitch to a vibration frequency value, and control the haptic motor to emit the haptic vibration at the vibration frequency value such that the sound of the haptic vibration is tuned to match the pitch. The first computing device and the second computing device are different models, form factors, or brands of devices, and the pitch of the haptic vibration emitted by the first computing device is substantially the same pitch as the pitch of the haptic vibration emitted by the second device. In this aspect, additionally or alternatively, the processor of the first computing device may be further configured to determine a resonant frequency of the first computing device, modify a conversion table of reference vibration frequency values and reference pitches by the resonant frequency, and convert the pitch to be emitted by the first computing device to the vibration frequency value based on the conversion table.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device with haptic tuning, comprising:
a haptic motor configured to emit a haptic vibration;
memory storing instructions; and
a processor configured to execute the instructions to:
execute a haptics engine configured to control the haptic motor and adjust the haptic vibration to be emitted;
receive haptic parameters including at least a pitch of a sound of the haptic vibration to be emitted;
convert the pitch to a vibration frequency value; and
control the haptic motor to emit the haptic vibration at the vibration frequency value such that the sound of the haptic vibration is tuned to match the pitch.

2. The computing device of claim 1, further comprising a speaker configured to emit a sound effect, wherein
the processor is further configured to harmonize the pitch of the haptic vibration with the sound effect.

3. The computing device of claim 1, further comprising a speaker configured to emit a sound effect, wherein
the processor is further configured to control the pitch of the haptic vibration to minimize dissonance with the sound effect.

4. The computing device of claim 1, wherein the computing device is a mobile device, tablet computing device, wearable computing device, or gaming device.

5. The computing device of claim 1, wherein
the haptics engine includes an application programming interface (API) configured to receive the haptic parameters from a user,
the haptic parameters further include an intensity and a duration, and
the haptics engine is configured to control the haptic motor to emit the haptic vibration at the intensity and for the duration of the haptic parameters.

6. The computing device of claim 1, wherein the computing device is a first computing device,
the pitch of the haptic vibration is substantially the same pitch as a pitch of a haptic vibration emitted by a second device executing a respective haptics engine, and
the first computing device and the second computing device are different models, form factors, or brands of devices.

7. The computing device of claim 1, wherein the processor is further configured to:
determine a resonant frequency of the computing device;
modify a conversion table of reference vibration frequency values and reference pitches by the resonant frequency; and
convert the pitch to the vibration frequency value based on the conversion table.

8. The computing device of claim 1, wherein the haptics engine is configured to control the haptic motor to emit a plurality of haptic vibrations having respective pitches selected from a predetermined musical key.

9. The computing device of claim 1, wherein the haptics engine is configured to control the haptic motor to emit a series of haptic vibrations tuned to a melody of corresponding pitches.

10. A method for haptic tuning in a computing device, comprising:
providing a haptic motor for emitting a haptic vibration;
executing a haptics engine configured to control the haptic motor and adjust the haptic vibration to be emitted;
receiving haptic parameters including at least a pitch of a sound of the haptic vibration to be emitted;
converting the pitch to a vibration frequency value; and
controlling the haptic motor to emit the haptic vibration at the vibration frequency value such that the sound of the haptic vibration is tuned to match the pitch.

11. The method of claim 10, further comprising:
emitting a sound effect via a speaker; and
harmonizing the pitch of the haptic vibration with the sound effect.

12. The method of claim 10, further comprising:
emitting a sound effect via a speaker; and
controlling the pitch of the haptic vibration to minimize dissonance with the sound effect.

13. The method of claim 10, wherein the computing device is a mobile device, tablet computing device, wearable computing device, or gaming device.

14. The method of claim 10, wherein
the haptic parameters are received from a user via an application programming interface (API) of the haptics engine,
the haptic parameters further include an intensity and a duration, and
the method further includes controlling the haptic motor to emit the haptic vibration at the intensity and for the duration of the haptic parameters.

15. The method of claim 10, wherein the computing device is a first computing device,
the pitch of the haptic vibration is substantially the same pitch as a pitch of a haptic vibration emitted by a second device executing a respective haptics engine, and
the first computing device and the second computing device are different models, form factors, or brands of devices.

16. The method of claim 10, further comprising:
determining a resonant frequency of the computing device;
modifying a conversion table of reference vibration frequency values and reference pitches by the resonant frequency; and
converting the pitch to the vibration frequency value based on the conversion table.

17. The method of claim 10, further comprising controlling the haptic motor to emit a plurality of haptic vibrations having respective pitches selected from a predetermined musical key.

18. The method of claim 10, further comprising controlling the haptic motor to emit a series of haptic vibrations tuned to a melody of corresponding pitches.

19. A computing system, comprising:
a first computing device with haptic tuning, and a second device with haptic tuning, each device respectively comprising:
a haptic motor configured to emit a haptic vibration;
memory storing instructions; and
a processor configured to execute the instructions to:
execute a haptics engine configured to control the haptic motor and adjust the haptic vibration to be emitted;
receive haptic parameters including at least a pitch of a sound of the haptic vibration to be emitted;
convert the pitch to a vibration frequency value; and
control the haptic motor to emit the haptic vibration at the vibration frequency value such that the sound of the haptic vibration is tuned to match the pitch, wherein
the first computing device and the second computing device are different models, form factors, or brands of devices, and
the pitch of the haptic vibration emitted by the first computing device is substantially the same pitch as the pitch of the haptic vibration emitted by the second device.

20. The computing system of claim 19, wherein the processor of the first computing device is further configured to:
determine a resonant frequency of the first computing device;
modify a conversion table of reference vibration frequency values and reference pitches by the resonant frequency; and
convert the pitch to be emitted by the first computing device to the vibration frequency value based on the conversion table.
